(19) United States
(12) Patent Application Publication
(10) Pub. No.: US 2025/0299341 A1
(43) Pub. Date: Sep. 25, 2025

(54) METHOD AND SYSTEM FOR PREDICTING TRAJECTORY USING LARGE LANGUAGE MODEL

(71) Applicant: GWANGJU INSTITUTE OF SCIENCE AND TECHNOLOGY, Gwangju (KR)

(72) Inventors: Hae Gon JEON, Gwangju (KR); In Hwan BAE, Gwangju (KR); Jun Oh LEE, Gwangju (KR)

(73) Assignee: GWANGJU INSTITUTE OF SCIENCE AND TECHNOLOGY, Gwangju (KR)

(21) Appl. No.: 18/986,359

(22) Filed: Dec. 18, 2024

(30) Foreign Application Priority Data
Mar. 19, 2024 (KR) 10-2024-0037756

(51) Int. Cl. G06T 7/20; G06V 20/70

(52) U.S. Cl. CPC G06T 7/20; G06V 20/70; G06T 2207/20084; G06T 2207/30241

(57) ABSTRACT

A method of predicting a trajectory is provided. The method may include: receiving an image capturing a pedestrian; specifying position coordinates of the pedestrian on the basis of the image and generating a caption corresponding to the image using an image captioning model; generating a numerical coordinate prompt for a past trajectory on the basis of the position coordinates, and generating a scene description prompt for surrounding situations on the basis of the caption; and predicting a trajectory of the pedestrian corresponding to the numerical coordinate prompt and the scene description prompt using a language model.

### CROSS REFERENCE TO RELATED APPLICATION

The present application claims priority to Korean Patent Application No. 10-2024-0037756, filed on Mar. 19, 2024, the entire contents of which is incorporated herein for all purposes by this reference.

### BACKGROUND OF THE INVENTION

### Field of the Invention

The present invention relates to a method and system for predicting a trajectory using a large-scale language model.

### DESCRIPTION OF GOVERNMENT-SPONSORED RESEARCH

The present invention was carried out with support from the national research and development project, with the unique project identification number being 1711193897 and the project number being 2019-0-01842-005. The project related to the present invention is supervised by the Ministry of Science and ICT, and managed by the Institute of Information and Communications Technology Planning and Evaluation (IITP). The research program is titled “ICT Broadcasting Innovation Talent Development Project,” and the research project is named “Support for AI Graduate Schools (GIST).” The project executing institution is Gwangju Institute of Science and Technology, and the research period is from Jan. 1, 2023, to Dec. 31, 2023.

In addition, the present invention was carried out with support from the national research and development project, with the unique project identification number being 1711196775 and the project number being S1602-20-1001. The project related to the present invention is supervised by the Ministry of Science and ICT, and managed by the National IT Industry Promotion Agency (NIPA). The research program is titled “AI-Centered Industrial Convergence Cluster Development (R&D) Project,” and the research project is named “Development of Customized Autonomous Driving Software Platform Technology for Specific-Purpose Vehicles.” The project executing institution is Autonomous a2z Co., Ltd., and the research period is from Jan. 1, 2023, to Dec. 31, 2023.

In addition, the present invention was carried out with support from the national research and development project, with the unique project identification number being 1415183637 and the project number being P0019797. The project related to the present invention is supervised by the Ministry of Trade, Industry, and Energy, and managed by the Korea Institute for Advancement of Technology (KIAT). The research program is titled “International Collaborative Technology Development Project,” and the research project is named “Development of a User-Participatory Metaverse Performance Solution Based on Neural Human Modeling.” The project executing institution is WYSIWYG Studios Co., Ltd., and the research period is from Dec. 1, 2022, to Nov. 30, 2023.

In addition, the present invention was carried out with support from the national research and development project, with the unique project identification number being 1711139517 and the project number being 2021-0-02068-001. The project related to the present invention is supervised by the Ministry of Science and ICT, and managed by the Institute of Information and Communications Technology Planning and Evaluation (IITP). The research program is titled “ICT Broadcasting Innovation Talent Development (R&D) Project,” and the research project is named “Research and Development of AI Innovation Hub.” The project executing institution is Korea University, and the research period is from Jul. 1, 2021, to Dec. 31, 2023.

In addition, the present invention was carried out with support from the national research and development project, with the unique project identification number being 2610000173 and the project number being RS-2023-00256888. The project related to the present invention is supervised by the Ministry of Land, Infrastructure and Transport, and managed by the Korea Agency for Infrastructure Technology Advancement (KAIA). The research program is titled “Urban Convergence Technology Research and Development Project,” and the research project is named “Development of AI-Based Hyperconnected Mobility Safety Technology.” The project executing institution is Gwangju Institute of Science and Technology, and the research period is from Apr. 1, 2023, to Dec. 31, 2024.

### DESCRIPTION OF THE RELATED ART

Recently, research on predicting the trajectories of surrounding pedestrians in congested environments, where systems such as path planning, social robots, and autonomous navigation are operated, has been actively conducted.

For example, in methods for predicting the trajectory of a pedestrian, a method has been proposed to predict the future trajectory of a pedestrian with a series of coordinate sequences corresponding to the pedestrian's position as input, on the basis of a model trained to predict the next sequence given a sequence input.

Meanwhile, recently, language models trained using large-scale language data have been proposed. These language models are trained to analyze text using a tokenizer embedded within the language model, and, on the basis of this analysis, to understand the context across various fields and provide corresponding output data.

### SUMMARY OF THE INVENTION

The present invention relates to a method and system for predicting the trajectory of a pedestrian using a large-scale language model.

In addition, the present invention relates to a method and system for predicting a trajectory using a large-scale language model, in which the language model is trained to be suitable for predicting the future trajectory of a pedestrian.

In addition, the present invention relates to a method and system for predicting a trajectory using a large-scale language model, in which the future trajectory of a pedestrian is accurately predicted using a language model that has undergone prompt engineering.

In addition, the present invention relates to a method and system for training a language model in an end-to-end manner using a trajectory predicted through a large-scale language model.

To solve the aforementioned objects, there is provided a method of predicting a trajectory, according to the present invention. The method may include: receiving an image capturing a pedestrian; specifying position coordinates of the pedestrian on the basis of the image and generating a caption corresponding to the image using a pre-provided image captioning model; generating a numerical coordinate prompt for a past trajectory of the pedestrian on the basis of the position coordinates, and generating a scene description prompt for surrounding situations of the pedestrian on the basis of the caption; and predicting a trajectory of the pedestrian corresponding to the numerical coordinate prompt and the scene description prompt using a pre-trained language model.

In addition, there is provided a system for predicting a trajectory, according to the present invention. The system may include: an input unit configured to receive an image capturing a pedestrian; and a control unit configured to predict a trajectory of the pedestrian based on the image using a pre-trained language model, in which the control unit may be configured to specify position coordinates of the pedestrian on the basis of the image, generate a caption corresponding to the image using a pre-provided image captioning model, generate a numerical coordinate prompt for a past trajectory of the pedestrian on the basis of the position coordinates, generate a scene description prompt for surrounding situations of the pedestrian on the basis of the caption, and predict a trajectory of the pedestrian corresponding to the numerical coordinate prompt and the scene description prompt using the pre-trained language model.

In addition, there is provided a program stored on a computer-readable recording medium, and executed by one or more processes in an electronic device, according to the present invention. The program may include instructions to allow the program to perform: receiving an image capturing a pedestrian; specifying position coordinates of the pedestrian on the basis of the image and generating a caption corresponding to the image using a pre-provided image captioning model; generating a numerical coordinate prompt for a past trajectory of the pedestrian on the basis of the position coordinates, and generating a scene description prompt for surrounding situations of the pedestrian on the basis of the caption; and predicting a trajectory of the pedestrian corresponding to the numerical coordinate prompt and the scene description prompt using a pre-trained language model.

To solve the aforementioned objects, there is provided a language model training method, according to the present invention. The language model training method may include: receiving an image capturing a pedestrian; specifying position coordinates of the pedestrian on the basis of the image and generating a caption corresponding to the image using a pre-provided image captioning model; generating a numerical coordinate prompt for a past trajectory of the pedestrian on the basis of the position coordinates, and generating a scene description prompt for surrounding situations of the pedestrian on the basis of the caption; predicting a trajectory of the pedestrian corresponding to the numerical coordinate prompt and the scene description prompt using a pre-trained first language model; and labeling the predicted trajectory as correct answer data for query data, which is based on the numerical coordinate prompt and the scene description prompt, and training a second language model in an end-to-end manner using the query data and the trajectory so that, when query data for an arbitrary pedestrian is input, the second language model outputs a trajectory corresponding to the input query data.

In addition, there is provided a language model training system, according to the present invention. The language model training system may include: an input unit configured to receive an image capturing a pedestrian; and a control unit configured to predict a trajectory of the pedestrian based on the image using a pre-trained first language model, and to train a second language model on the basis of the predicted trajectory, in which the control unit may be configured to specify position coordinates of the pedestrian on the basis of the image, generate a caption corresponding to the image using a pre-provided image captioning model, generate a numerical coordinate prompt for a past trajectory of the pedestrian on the basis of the position coordinates, generate a scene description prompt for surrounding situations of the pedestrian on the basis of the caption, predict a trajectory of the pedestrian corresponding to the numerical coordinate prompt and the scene description prompt using the first language model, label the predicted trajectory as correct answer data for query data, which is based on the numerical coordinate prompt and the scene description prompt, and train the second language model in an end-to-end manner using the query data and the trajectory so that, when query data for an arbitrary pedestrian is input, the second language model outputs a trajectory corresponding to the input query data.

In addition, there is provided a program stored on a computer-readable recording medium, and executed by one or more processes in an electronic device, according to the present invention. The program may include instructions to allow the program to perform: receiving an image capturing a pedestrian; specifying position coordinates of the pedestrian on the basis of the image and generating a caption corresponding to the image using a pre-provided image captioning model; generating a numerical coordinate prompt for a past trajectory of the pedestrian on the basis of the position coordinates, and generating a scene description prompt for surrounding situations of the pedestrian on the basis of the caption; predicting a trajectory of the pedestrian corresponding to the numerical coordinate prompt and the scene description prompt using a pre-trained first language model; and labeling the predicted trajectory as correct answer data for query data, which is based on the numerical coordinate prompt and the scene description prompt, and training a second language model in an end-to-end manner using the query data and the trajectory so that, when query data for an arbitrary pedestrian is input, the second language model outputs a trajectory corresponding to the input query data.

According to various embodiments of the present invention, the method and system for predicting a trajectory using a large-scale language model can generate a prompt describing the past trajectory of a pedestrian from the image, and train the language model to be suitable for predicting the future trajectory of the pedestrian by performing prompt engineering on the language model using the generated prompt.

In addition, according to various embodiments of the present invention, the method and system for predicting a trajectory using a large-scale language model can input a question related to the future trajectory of a pedestrian into the language model that has undergone prompt engineering, thereby accurately predicting the trajectory that the corresponding pedestrian will proceed in the future.

### BRIEF DESCRIPTION OF THE DRAWINGS

FIG. 1 and FIG. 2 illustrate a system for predicting a trajectory according to the present invention.

FIG. 3 to FIG. 5 illustrate an embodiment for predicting a trajectory.

FIG. 6 is a flowchart illustrating a method of predicting a trajectory according to the present invention.

FIG. 7 illustrates an embodiment for specifying position coordinates.

FIG. 8 illustrates an embodiment for generating a caption.

FIG. 9 illustrates an embodiment for generating a numerical coordinate prompt.

FIG. 10 illustrates an embodiment for segmenting a prompt using a tokenizer.

FIG. 11 illustrates an embodiment representing a question-answer template.

FIG. 12 and FIGS. 13A to 13F illustrate an embodiment for predicting a pedestrian's trajectory.

### DETAILED DESCRIPTION OF THE INVENTION

Hereinafter, exemplary embodiments disclosed in the present specification will be described in detail with reference to the accompanying drawings. The same or similar constituent elements are assigned with the same reference numerals regardless of reference numerals, and the repetitive description thereof will be omitted. The suffixes “module”, “unit”, “part”, and “portion” used to describe constituent elements in the following description are used together or interchangeably in order to facilitate the description, but the suffixes themselves do not have distinguishable meanings or functions. In addition, in the description of the exemplary embodiment disclosed in the present specification, the specific descriptions of publicly known related technologies will be omitted when it is determined that the specific descriptions may obscure the subject matter of the exemplary embodiment disclosed in the present specification. In addition, it should be interpreted that the accompanying drawings are provided only to allow those skilled in the art to easily understand the embodiments disclosed in the present specification, and the technical spirit disclosed in the present specification is not limited by the accompanying drawings, and includes all alterations, equivalents, and alternatives that are included in the spirit and the technical scope of the present invention.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element exists between the constituent elements.

Singular expressions include plural expressions unless clearly described as different meanings in the context.

In the present application, it should be understood that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance.

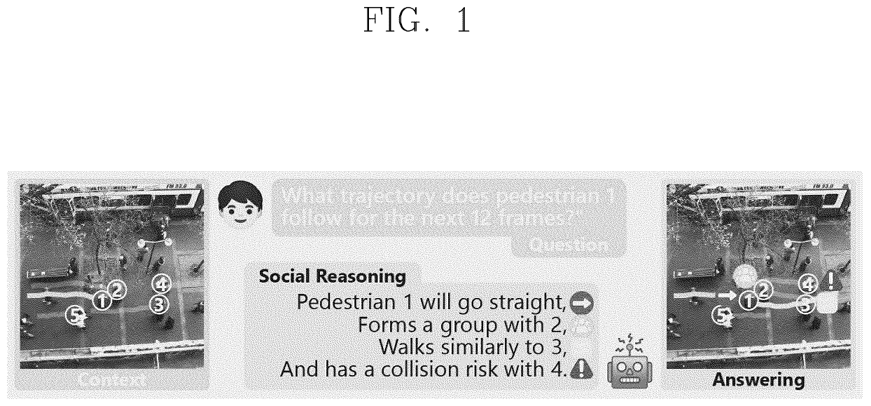

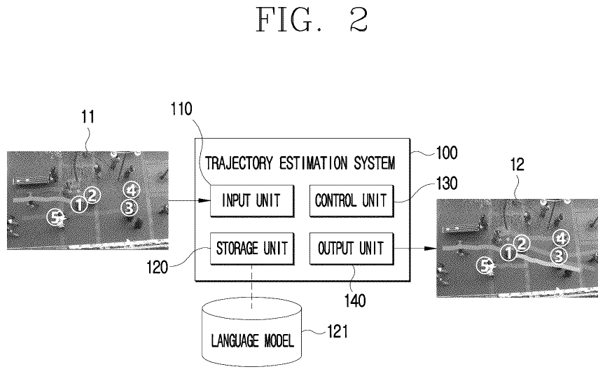

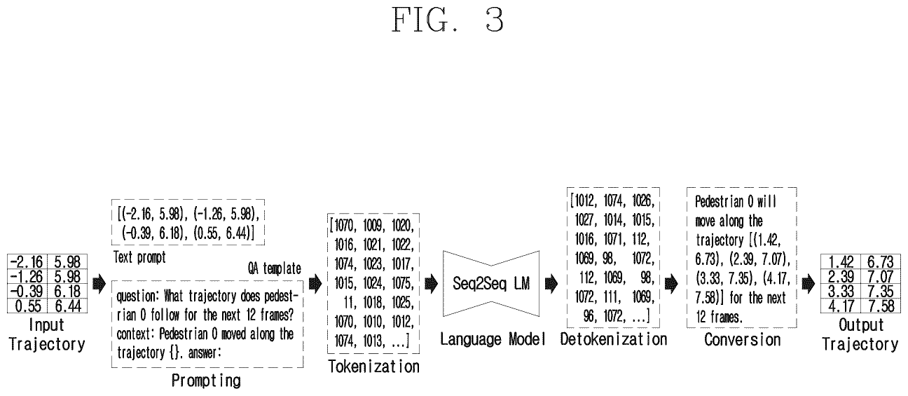

FIG. 1 and FIG. 2 illustrate a system for predicting a trajectory according to the present invention. FIG. 3 to FIG. 5 illustrate an embodiment for predicting a trajectory.

With reference to FIG. 1 and FIG. 2 together, a system 100 for predicting a trajectory according to the present invention generates a prompt corresponding to a pedestrian's position and surrounding situations on the basis of a predetermined image 11. The generated prompt is used to perform prompt engineering on a pre-trained language model 121, and using the language model 121, which has undergone prompt engineering, the trajectory of the pedestrian appearing in the image 11 may be predicted.

In this case, the system 100 for predicting a trajectory may input query data (e.g., Question) into the language model 121 that has undergone prompt engineering, and generate answer data 12 (e.g., Social Reasoning) that predicts the pedestrian's trajectory, thereby allowing the system to predict the pedestrian's trajectory.

Here, the language model 121 may be trained using large-scale language data, and learn the sequence of a plurality of words based on this large-scale language data. The language model 121 then may predict the probability of one or more words corresponding to a specific word, and be trained to output a specific sentence or word on the basis of the predicted probability values.

Such a language model 121 may be an natural language processing (NLP) model trained based on a transformer architecture, and depending on the embodiment, may include models such as a masked language model (MLM), a large language model (LLM), or a causal language model (CLM).

In this regard, the prompt may be implemented to provide guidelines in the process of generating output data corresponding to input data from the language model 121. That is, the system 100 for predicting a trajectory may input a predetermined prompt into the pre-trained language model 121 to perform prompt engineering, thereby generating output data corresponding to the input data that is input after prompt engineering is performed, on the basis of the previously input prompt.

In this case, prompt engineering may involve inputting a prompt into the language model 121 to enable the language model 121 to learn the guidelines in the process of generating output data corresponding to the input data.

To this end, the prompt may include a numerical coordinate prompt and a scene description prompt.

The numerical coordinate prompt may be a prompt that includes information related to a position of the pedestrian appearing in the predetermined image 11. In this case, the numerical coordinate prompt may list the positions of the pedestrian appearing in each of the plurality of images 11 in a time series. Therefore, the language model 121 may learn a path along which the pedestrian has moved in the past.

In addition, the scene description prompt may be a prompt that includes information related to the surrounding situations of the pedestrian appearing in the predetermined image 11. In this case, the scene description prompt may include information on various environmental aspects such as the arrangement of buildings and vehicles existing around the pedestrian, population density, and the flow of pedestrians.

The system 100 for predicting a trajectory may use a pre-provided image captioning model to generate a caption corresponding to the predetermined image 11, and on the basis of the generated caption, generate a scene description prompt.

Here, the image captioning model may analyze the image 11 to extract feature vectors, generate keywords (or words) corresponding to the features appearing in the image 11 on the basis of the extracted feature vectors, and generate a sentence (or word) corresponding to the image 11 as a caption for the image, on the basis of the generated keywords.

Such an image captioning model may be implemented by combining a convolutional neural network (CNN) and long short-term memory (LSTM) to generate a caption from the predetermined image 11.

Meanwhile, the query data is a sentence corresponding to a question related to the pedestrian's trajectory, and may be generated on the basis of at least one of the numerical coordinate prompt or the scene description prompt, which are input into the language model 121 during the prompt engineering process.

For example, the query data may include a question related to the trajectory of a specific pedestrian, along with the past trajectory (or current position coordinates) of the corresponding pedestrian. In this case, the question related to the trajectory may, depending on the embodiment, include questions related to the pedestrian's destination, questions about the direction of movement, and the like.

As another example, the query data may include the past trajectory of the corresponding pedestrian along with a question related to the social relationship between the corresponding pedestrian and other pedestrians, based on the trajectory of the specific pedestrian. In this case, the question related to the social relationship may, depending on the embodiment, include questions regarding other pedestrians with a similar trajectory to the corresponding pedestrian, questions about other pedestrians moving together with the corresponding pedestrian, and questions related to the possibility of a collision between the corresponding pedestrian and other pedestrians.

Accordingly, when receiving a plurality of images 11 in a time series, the system 100 for predicting a trajectory may generate a numerical coordinate prompt and a scene description prompt from the plurality of images corresponding to the past, relative to a specific image 11, and perform prompt engineering on the language model 121. The system 100 for predicting a trajectory may generate at least one of the numerical coordinate prompt or the scene description prompt from the specific image 11 to generate query data on the basis of at least one of the generated numerical coordinate prompt or scene description prompt.

Therefore, the system 100 for predicting a trajectory may obtain answer data 12 corresponding to the query data as the trajectory of the pedestrian appearing in the image 11.

In this regard, the trajectory predicted by the language model 121 may be a prediction of the future position of a specific pedestrian, based on the past positions appearing from the predetermined image 11, for example, may involve predicting a sequence of future position coordinates for the corresponding pedestrian based on the sequence of position coordinates extracted for the specific pedestrian from the plurality of images.

In addition, the trajectory predicted by the language model 121 may be output in the form of answer data corresponding to the query data input into the language model 121. In this case, the answer data may be generated in a predetermined text format.

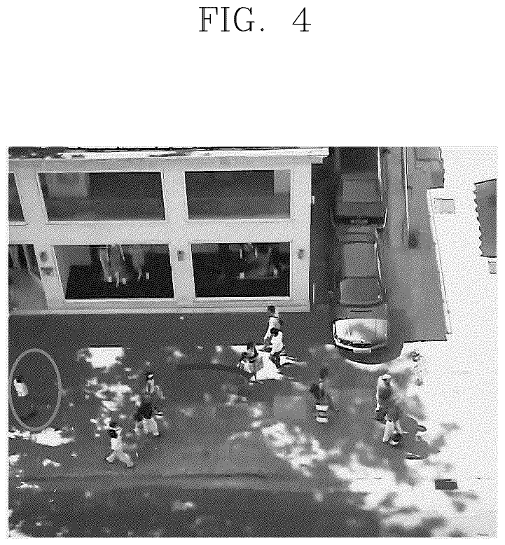

In this regard, with reference to FIG. 3 and FIG. 4, the system 100 for predicting a trajectory may use a plurality of images capturing a specific pedestrian designated inside the left circular area (e.g., a plurality of images captured over 8 frames or 3.2 seconds) to specify a plurality of position coordinates along which the corresponding pedestrian has moved in the past (e.g., input trajectory in FIG. 3 and a line illustrated at the center in FIG. 4).

Accordingly, the system 100 for predicting a trajectory may generate a numerical coordinate prompt (e.g., text prompt) on the basis of the previously specified plurality of position coordinates and perform prompt engineering on the language model using the generated numerical coordinate prompt.

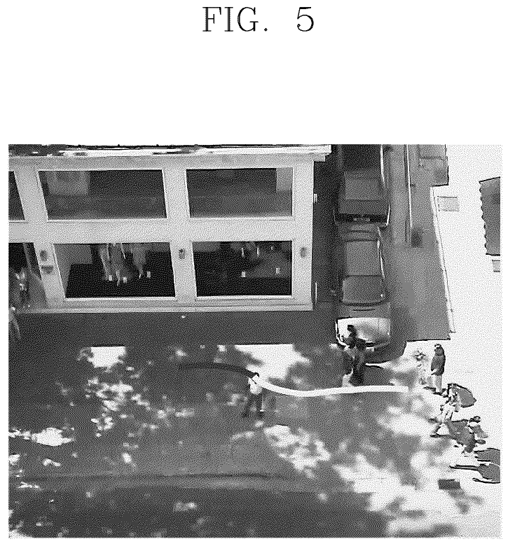

Next, with further reference to FIG. 5, the system 100 for predicting a trajectory may generate query data (e.g., QA template) for a specific pedestrian, and input the previously generated query data into the language model that has undergone prompt engineering. Using this input, thereby predicting the trajectory of the corresponding pedestrian (e.g., output trajectory in FIG. 4, and right-side line of lines illustrated at the center in FIG. 5).

In this case, the trajectory predicted through the language model may be a path along which the pedestrian is predicted to move over a predetermined time interval (e.g., a time interval corresponding to 12 frames or 4.8 seconds). That is, the system 100 for predicting a trajectory may predict the trajectory of the pedestrian to correspond to the plurality of images for which the plurality of position coordinates have been specified.

In an embodiment, the system 100 for predicting a trajectory may predict a future trajectory according to Equation 2 with respect to a past trajectory of the pedestrian as given by Equation 1 below.

$${S}_{n , obs} = \{ ( {x}_{n}^{t} , {y}_{n}^{t} ) ∈ {R}^{2} \vert t ∈ [ 1 , … , {T}_{obs} ] \} \qquad Equation 1$$

$${S}_{n , pred} = \{ ( {x}_{n}^{t} , {y}_{n}^{t} ) ∈ {R}^{2} \vert t ∈ [ {T}_{obs} + 1 , … , {T}_{obs} + {T}_{pred} ] \} \qquad Equation 2$$

Here, S_{n, ob.} represents a past trajectory, S_{n, pred} represents a future trajectory, T_{ob}. is a first time interval corresponding to the past trajectory, and T_{pred} is a second time interval corresponding to the future trajectory.

Accordingly, the system 100 for predicting a trajectory may extract the position coordinates of the pedestrian from each of the plurality of images corresponding to the first time interval to generate the past trajectory. Then, using the prompt for the generated past trajectory, the system 100 predicts the future trajectory corresponding to the second time interval.

In this case, the past trajectory may include a plurality of position coordinates extracted from each of the plurality of images according to the first time interval, and the future trajectory may include a plurality of position coordinates according to the second time interval, in a manner corresponding to the past trajectory.

Meanwhile, a language model training system according to the present invention may train the language model in an end-to-end manner on the basis of the configurations described above.

Specifically, the language model training system may train the language model using the query data generated for a specific pedestrian and the trajectory (or answer data) output from the language model that has undergone prompt engineering, corresponding to the query data.

To this end, the language model training system may label the trajectory as correct answer data for the query data, and train the language model so that when query data for any pedestrian is input, the model outputs a trajectory (or answer data) corresponding to the input query data, using the query data and the trajectory (or answer data).

Accordingly, when the system for predicting a trajectory is provided with the language model in an end-to-end manner described above, the system may generate a prompt corresponding to the pedestrian's position and the surrounding situations on the basis of the predetermined image, then generate query data on the basis of the generated prompt, and input the previously generated query data into the language model to predict the pedestrian's trajectory.

Alternatively, the language model training system may also train the language model using the query data generated for a specific pedestrian and the trajectory (or answer data) generated on the basis of a user input for the corresponding query data.

With reference back to FIG. 2, the system 100 for predicting a trajectory according to the present invention may include an input unit 110, a storage unit 120, a control unit 130, and an output unit 140.

The input unit 110 may be connected to a server or another device, in which the predetermined image 11 is stored, via a wireless or wired network, and may receive the predetermined image 11 from the connected server or another device.

In this case, the input unit 110 may also receive a new image 11 from the server or another device at predetermined time intervals.

For example, the input unit 110 may be connected to a closed-circuit camera (e.g., closed-circuit television (CCTV)), and receive newly captured images 11 from the closed-circuit camera at predetermined time intervals.

As another example, the input unit 110 may be connected to a camera provided to capture one side of a vehicle and receive images 11 captured by the camera at predetermined time intervals.

In addition, the input unit 110 may be connected to an input device provided to receive user commands via a wireless or wired network, and recognize user commands received from the input device and generate query data corresponding to the user commands.

In this case, the input device may be a device provided to input predetermined commands (e.g., text, etc.), and may include a keyboard, a touchpad, input buttons provided to generate predetermined signals, or the like.

Accordingly, the input unit 110 may generate query data on the basis of the signal received from the input device, or specify one of the plurality of predetermined query data that corresponds to the signal received from the input device.

The storage unit 120 may store commands and data necessary for the operation of the system 100 for predicting a trajectory according to the present invention.

For example, the storage unit 120 may store the pre-trained language model 121, as well as the image 11, and the numerical coordinate prompt and scene description prompt generated on the basis of the image 11.

In addition, the storage unit 120 may store the query data input through the input unit 110, as well as information related to the pedestrian's trajectory generated in response to the query data.

In addition, the storage unit 120 may store the image captioning model, as well as the information required to generate the numerical coordinate prompt and the scene description prompt.

The control unit 130 may control the overall operation of the system 100 for predicting a trajectory according to the present invention.

For example, the control unit 130 may receive the image 11, generate a numerical coordinate prompt and a scene description prompt on the basis of the received image 11, and perform prompt engineering on the language model 121 on the basis of the numerical coordinate prompt and the scene description prompt.

In addition, the control unit 130 may receive query data and input the query data into the language model 121, which has undergone prompt engineering, to predict the trajectory of the pedestrian.

The output unit 140 may output various information generated by the control unit 130. To this end, the output unit 140 may be connected to a display device that induces visual stimuli to the user, via a wireless or wired network.

Accordingly, the output unit 140 may output at least one of the image 11, the numerical coordinate prompt, the scene description prompt, or the query data, as well as output the trajectory of the pedestrian.

In this regard, the language model training system according to the present invention may be implemented in a form similar to the system 100 for predicting a trajectory.

For example, the language model training system may include an input unit, a storage unit, and a control unit, in which the input unit may receive a predetermined image. In addition, the input unit may recognize user commands and generate one or more of query data corresponding to the user commands or the trajectory (or answer data) of the pedestrian.

The storage unit may store commands and data necessary for the operation of the language model training system according to the present invention. For example, the storage unit may store one or more of a pre-trained language model or a target language model. In this case, the pre-trained language model may be trained to process predetermined language data on the basis of large-scale training data, while the target language model may be a language model that is to be trained in an end-to-end manner to predict the pedestrian's trajectory on the basis of a predetermined prompt (or image).

The control unit may generate a prompt on the basis of the predetermined image and use the pre-trained language model to predict the pedestrian's trajectory from the prompt.

In addition, the control unit may train the target language model using the previously generated prompt and the previously predicted trajectory.

With the configuration of the system 100 for predicting a trajectory as described above, a more detailed description of a method of predicting a trajectory will be provided below.

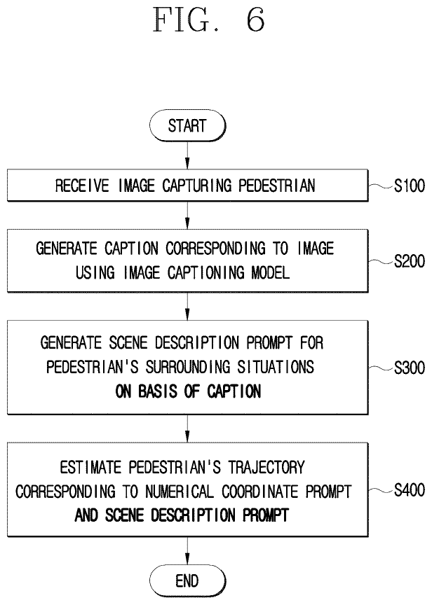

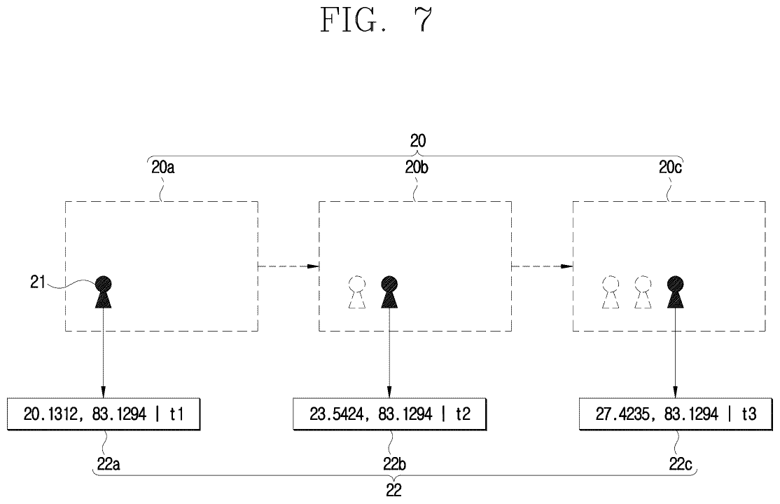

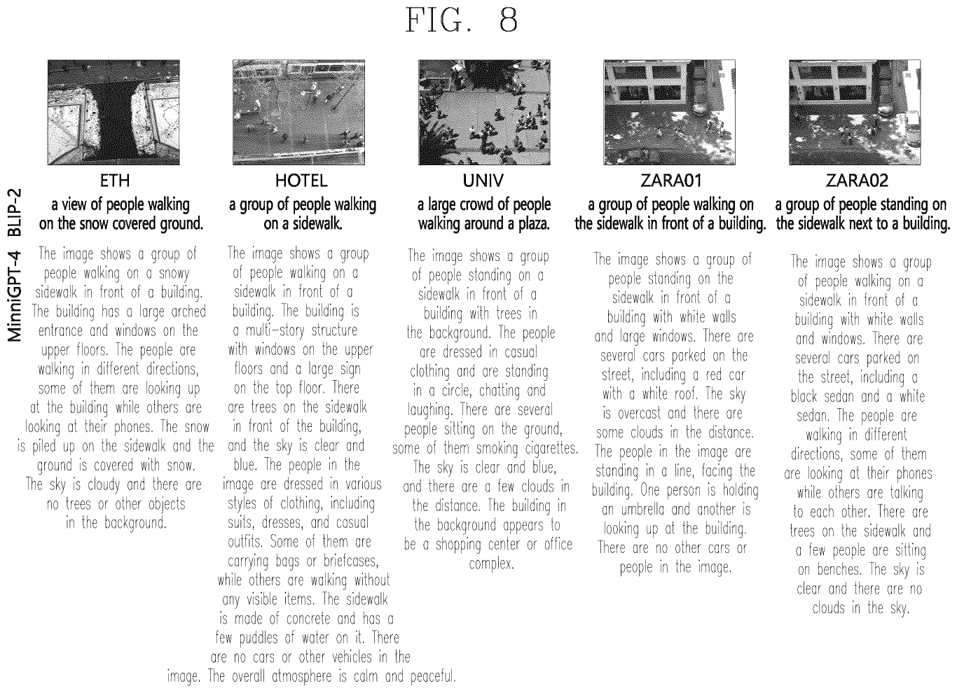

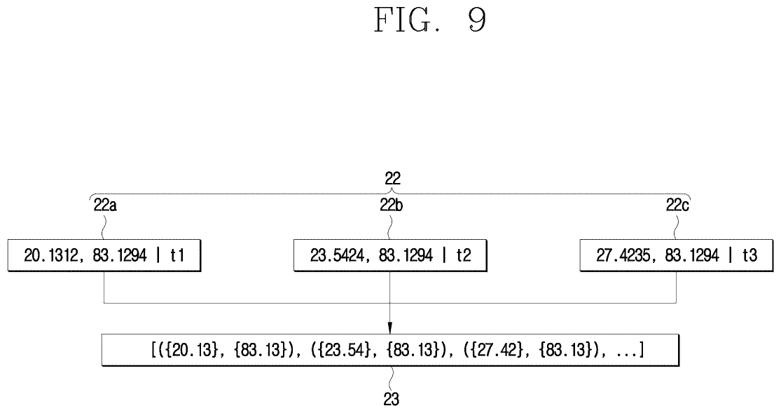

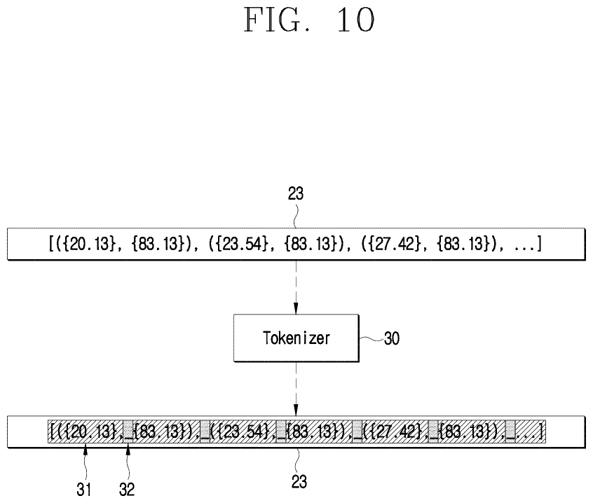

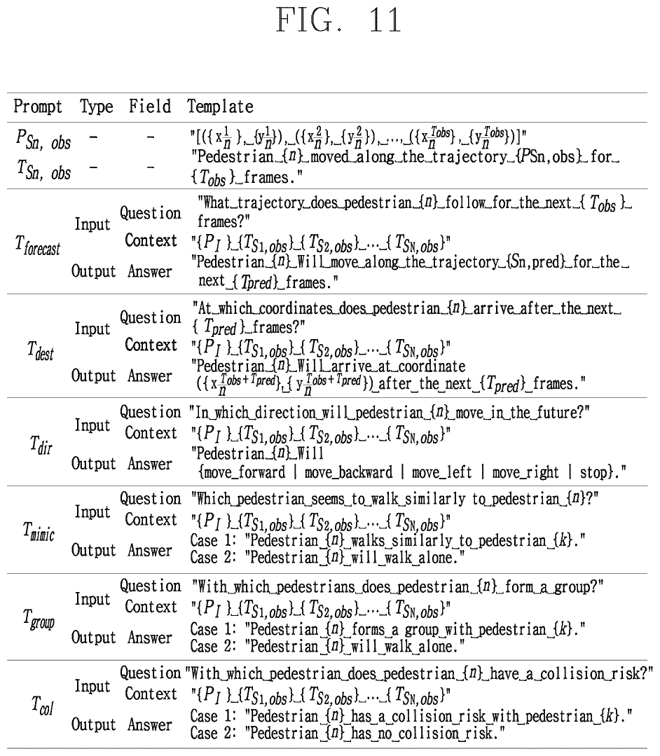

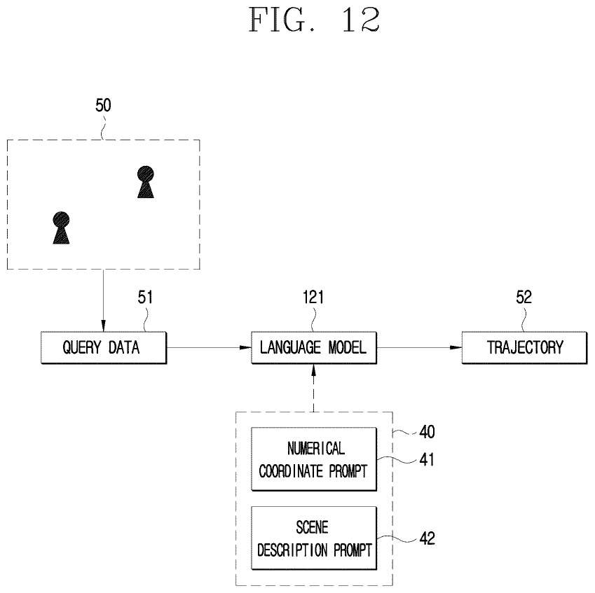

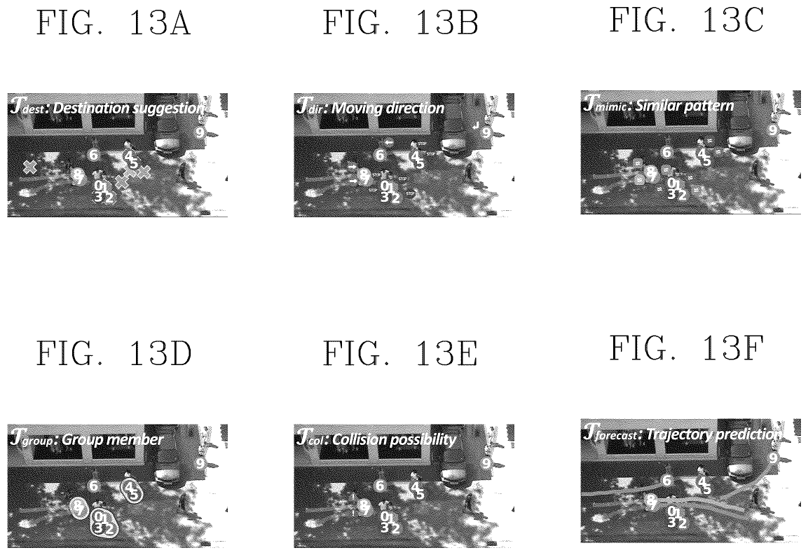

FIG. 6 is a flowchart illustrating a method of predicting a trajectory according to the present invention. FIG. 7 illustrates an embodiment for specifying position coordinates. FIG. 8 illustrates an embodiment for generating a caption. FIG. 9 illustrates an embodiment for generating a numerical coordinate prompt. FIG. 10 illustrates an embodiment for segmenting a prompt using a tokenizer. FIG. 11 illustrates an embodiment representing a question-answer template. FIG. 12 and FIGS. 13A to 13F illustrate an embodiment for predicting a pedestrian's trajectory.

With reference to FIG. 6, the system 100 for predicting a trajectory according to the present invention may receive an image capturing a pedestrian (S100), specify the position coordinates of the pedestrian on the basis of the received image, and use a pre-provided image captioning model to generate a caption corresponding to the image (S200).

Specifically, the system 100 for predicting a trajectory may receive a plurality of images captured at predetermined time intervals.

For example, the system 100 for predicting a trajectory may receive a plurality of images from a pre-provided camera, captured according to the capturing intervals of the corresponding camera.

As another example, the system 100 for predicting a trajectory may receive an image configured of a plurality of frames in a time series from a pre-provided server.

In this case, the image may be a top-down view image, captured from a specific position above the pedestrian, in a point of view of looking down at the pedestrian.

Further, the system 100 for predicting a trajectory may specify the position coordinates of one or more pedestrians included in each of the previously received plurality of images.

With reference to FIG. 7, for example, the system 100 for predicting a trajectory may use a pre-trained pedestrian prediction model or the like to predict the position of a pedestrian 21 in an image 20, and represent the position of the predicted pedestrian 21 in the form of coordinates, thereby specifying position coordinates 22 of the pedestrian.

In this case, the pedestrian prediction model may be trained to predict an object corresponding to the pedestrian 21 in the image 20, and, for example, may be a model trained based on a convolutional neural network (CNN).

In addition, the system 100 for predicting a trajectory may, when a predetermined reference position coordinates exist for a specific pixel in the image 20, specify the position coordinates of the pedestrian by adding the coordinates of the pixel corresponding to the position of the pedestrian 21 predicted from the image 20 to the reference position coordinates.

Meanwhile, when receiving a plurality of images 20a, 20b, and 20c, the system 100 for predicting a trajectory may specify time-series data (e.g., t1, t2, t3, etc.) corresponding to each of the plurality of images 20a, 20b, and 20c along with a plurality of position coordinates 22a, 22b, and 22c corresponding to the pedestrian 21, from each of the plurality of images 20a, 20b, and 20c.

As another example, the system 100 for predicting a trajectory may specify the position coordinates of each of a plurality of pedestrians appearing in the image. In this case, the system 100 for predicting a trajectory may specify the position coordinates of each of the plurality of pedestrians with coordinate values in the form of floating-point real numbers. Further, the system 100 for predicting a trajectory may generate a caption related to each of the previously received plurality of images using a pre-provided image captioning model.

For example, the system 100 for predicting a trajectory may use the BLIP-2 model, trained through ImageNet, to extract text describing the pedestrian and the pedestrian's surrounding situations in the image as a caption.

With reference to FIG. 8, as another example, the system 100 for predicting a trajectory may, depending on the embodiment, selectively use various image captioning models (e.g., BLIP-2 and MiniGPT-4, etc.) to generate a caption for the image.

With reference back to FIG. 6, the system 100 for predicting a trajectory according to the present invention may generate a numerical coordinate prompt for the past trajectory of the pedestrian on the basis of the previously specified position coordinates, and generate a scene description prompt for the pedestrian's surrounding situations on the basis of the previously generated caption (S300).

Specifically, the system 100 for predicting a trajectory may process the position coordinates of the pedestrian specified from each of the previously received plurality of images, according to a predetermined text format, and list the position coordinates specified and processed from the plurality of images according to the time series corresponding to the plurality of previously received images, thereby generating a numerical coordinate prompt.

With reference to FIG. 9, for example, the system 100 for predicting a trajectory may convert the position coordinates 22 of the pedestrian, which have been specified as predetermined coordinate values from the image, into a text format to generate a numerical coordinate prompt 23.

In this case, the system 100 for predicting a trajectory may round (or round up or down) the position coordinates 22 to a predetermined number of places (e.g., two decimal places), and insert one or more predetermined symbols (e.g., commas and parentheses) into one side of the position coordinates 22 converted into the predetermined number of places, thereby generating a numerical coordinate prompt 23, which is position coordinates in text format.

In addition, the system 100 for predicting a trajectory may generate the numerical coordinate prompt 23 by using time-series data (e.g., t1, t2, t3, etc.) corresponding to the image in which the position coordinates 22 of the pedestrian were previously specified, among the time series-based plurality of images, along with the position coordinates 22 of the pedestrian.

That is, the system 100 for predicting a trajectory may list the plurality of position coordinates 22a, 22b, and 22c in accordance with the time-series data and insert predetermined symbols (e.g., commas) between the different plurality of position coordinates 22a, 22b, and 22c to generate the numerical coordinate prompt 23 for the past trajectory of a specific pedestrian.

Further, the system 100 for predicting a trajectory may generate a scene description prompt on the basis of the caption generated from the image, ensuring that the scene description prompt includes descriptions for a predetermined plurality of detailed items regarding the pedestrian and the pedestrian's surrounding situations.

For example, the system 100 for predicting a trajectory may analyze the caption to extract one or more texts (e.g., sentences or keywords) corresponding to each of the predetermined plurality of detailed items, and combine the extracted one or more texts with the text corresponding to each of the predetermined plurality of detailed items (e.g., sentences or keywords) to generate the scene description prompt.

In this case, in an embodiment, the predetermined plurality of detailed items may include detailed information related to various environmental factors such as the arrangement of buildings and vehicles, pedestrian density, and the flow of pedestrians, as depicted in the image.

With reference back to FIG. 6, the system 100 for predicting a trajectory according to the present invention may predict the pedestrian's trajectory corresponding to the numerical coordinate prompt and scene description prompt using a pre-trained language model (S400).

Specifically, the system 100 for predicting a trajectory may input the numerical coordinate prompt and the scene description prompt into the pre-trained language model to perform prompt engineering on the language model.

For example, the system 100 for predicting a trajectory may input the numerical coordinate prompt and the scene description prompt into the pre-trained language model in a predetermined sequence to perform prompt engineering on the language model.

That is, the system 100 for predicting a trajectory may input the numerical coordinate prompt into the pre-trained language model, and subsequently input the scene description prompt as a description for the input numerical coordinates to perform prompt engineering.

Alternatively, the system 100 may input the scene description prompt into the pre-trained language model, and subsequently input the numerical coordinate prompt as the pedestrian's trajectory in the input scene description prompt to perform prompt engineering.

In this case, the system 100 for predicting a trajectory may use a pre-trained tokenizer to segment each of the numerical coordinate prompt and scene description prompt into a plurality of tokens according to predetermined criteria, and perform prompt engineering on the language model using the segmented plurality of tokens.

In this regard, the tokenizer may be trained to generate a plurality of tokens by separating values corresponding to position coordinates in the numerical coordinate prompt and by separating each word in the scene description prompt.

With reference to FIG. 10, in an embodiment, a tokenizer 30 may be trained to separate values 31 corresponding to the position coordinates inserted within the parentheses with respect to the numerical coordinate prompt 23 on the basis of commas (or spaces) (32).

In addition, the tokenizer 30 may be trained to separate coordinate values extracted from images corresponding to different time series with respect to the numerical coordinate prompt 23 on the basis of parentheses.

In addition, the tokenizer may be trained to separate words with respect to the scene description prompt on the basis of predetermined punctuation symbols such as spaces.

As another example, the system 100 for predicting a trajectory may substitute the numerical coordinate prompt and scene description prompt into a predetermined prompt engineering template to generate a prompt in a predetermined format, and input the previously generated prompt into the pre-trained language model to perform prompt engineering on the language model.

In an embodiment, the system 100 for predicting a trajectory may substitute the numerical coordinate prompt and scene description prompt into a pre-prepared prompt engineering template, where the numerical coordinate prompt and scene description prompt are separated by commas within square brackets, and input the prompt in which the numerical coordinate prompt and scene description prompt are previously substituted, into the language model to perform prompt engineering.

Further, the system 100 for predicting a trajectory may generate query data related to the trajectory of a specific pedestrian appearing in the image, on the basis of at least one of the numerical coordinate prompt or the scene description prompt.

For example, the system 100 for predicting a trajectory may detect a specific pedestrian appearing in the image and generate query data using text that queries the trajectory of the detected pedestrian, as well as text representing the past trajectory (or the position coordinates of the pedestrian in the current image) of the corresponding pedestrian.

In this case, the system 100 for predicting a trajectory may generate text representing the past trajectory of the specific pedestrian on the basis of the position coordinates of the corresponding pedestrian detected in each of the plurality of images listed in a time series (or included in the previously generated numerical coordinate prompt).

In addition, the system 100 for predicting a trajectory may generate query data by inputting, into a predetermined text format, information designating the specific pedestrian appearing in the image (e.g., an identification number for the pedestrian), and information representing a predetermined time interval (e.g., a predetermined number of frames), based on time-series data corresponding to the image (e.g., frames).

In this regard, when a plurality of pedestrians are detected in the image, the system 100 for predicting a trajectory may generate query data for each of the plurality of pedestrians.

As another example, the system 100 for predicting a trajectory may generate query data for a specific pedestrian on the basis of a user input. In this case, the system 100 for predicting a trajectory may generate query data for a specific pedestrian recognized from a predetermined image, or may generate query data for a hypothetical pedestrian on the basis of the image previously used for prompt engineering.

That is, the system 100 for predicting a trajectory may receive a text querying the trajectory of a hypothetical pedestrian along with the past trajectory of the corresponding pedestrian, on the basis of a user input, and predict the future trajectory of the hypothetical pedestrian using the received past trajectory and text.

With reference to FIG. 11, as another example, the system 100 for predicting a trajectory may generate at least one of the numerical coordinate prompt or the scene description prompt for a specific image, and generate query data by inserting at least one of the numerical coordinate prompt (e.g., P_Sn, obs) or the scene description prompt (e.g., T_Sn, obs) into a predetermined question-answer template (e.g., Template).

Here, the question-answer template is a template that has predetermined the form of the query data to be input into the language model, as well as the form in which the pedestrian's trajectory is output from the language model. The question-answer template is implemented so that information extracted based on the image (e.g., information related to the pedestrian and the numerical coordinate prompt) is inserted at predetermined positions in the query data. Additionally, the question-answer template may be implemented so that information output from the language model in response to the query data (e.g., information related to the pedestrian and future position coordinates) may be inserted at predetermined positions in the text corresponding to the answer and output accordingly.

In an embodiment, the question-answer template may include a template for performing prompt engineering. In this case, the corresponding template may be a template in which the format corresponding to the numerical coordinate prompt (e.g., P_Sn, obs) and the scene description prompt (e.g., T_Sn, obs) has been pre-designated.

In another embodiment, the question-answer template may include text corresponding to the answer to the predetermined question (e.g., Output-Answer), along with text corresponding to a predetermined question regarding a specific pedestrian appearing in a specific image (e.g., Input-Question), and the numerical coordinate prompt according to the position coordinates of the corresponding pedestrian in the corresponding image (e.g., Input-Context).

In this case, the text corresponding to the answer may include information included in the predetermined question (e.g., information regarding the specific pedestrian, information regarding the time series, etc.), as well as information regarding the position coordinates predicted based on the numerical coordinate prompt.

Accordingly, the system 100 for predicting a trajectory may generate query data by inserting text querying the trajectory of a specific pedestrian and the numerical coordinate prompt for the corresponding pedestrian into the question-answer template.

Further, the system 100 for predicting a trajectory may also generate query data related to the social relationship between a specific pedestrian and other pedestrians, on the basis of the trajectory of the specific pedestrian.

For example, the system 100 for predicting a trajectory may generate query data that asks about the position coordinates that a specific pedestrian will reach after a predetermined time (or frames).

In this regard, the system 100 for predicting a trajectory may have a question-answer template (e.g., T_dest) pre-prepared to correspond to the query data asking about the position coordinates that the specific pedestrian will reach.

As another example, the system 100 for predicting a trajectory may generate query data asking about a direction in which a specific pedestrian will proceed after a predetermined time (or frames).

In this regard, the system 100 for predicting a trajectory may have a question-answer template (e.g., T_dir) pre-prepared to correspond to the query data asking about the direction in which the specific pedestrian will proceed.

As another example, the system 100 for predicting a trajectory may generate query data that asks whether there are other pedestrians exhibiting a walking pattern similar to that of a specific pedestrian.

In this regard, the system 100 for predicting a trajectory may have a question-answer template (e.g., T_mimic) pre-prepared to correspond to the query data asking whether there are other pedestrians exhibiting a walking pattern similar to that of the specific pedestrian.

As another example, the system 100 for predicting a trajectory may generate query data asking whether there are other pedestrians walking together in the group to which a specific pedestrian belongs.

In this regard, the system 100 for predicting a trajectory may have a question-answer template (e.g., T_group) pre-prepared to correspond to the query data asking whether there are other pedestrians walking together in the group to which the specific pedestrian belongs.

As another example, the system 100 for predicting a trajectory may generate query data asking about the possibility of a collision for a specific pedestrian.

In this regard, the system 100 for predicting a trajectory may have a question-answer template (e.g., T_col) pre-prepared to correspond to the query data asking about the possibility of a collision for the specific pedestrian.

Further, the system 100 for predicting a trajectory may input the query data into the language model that has undergone prompt engineering, on the basis of the numerical coordinate prompt and scene description prompt, to predict the pedestrian's trajectory corresponding to the input query data.

With reference to FIG. 12, for example, the system 100 for predicting a trajectory may input query data 51, which includes text querying the trajectory of a specific pedestrian and text representing the past trajectory of the corresponding pedestrian, into the language model 121 that has undergone prompt engineering using a numerical coordinate prompt 41 and a scene description prompt 42 to predict a future trajectory 52 (or future position coordinates) generated on the basis of the past trajectory of the corresponding pedestrian.

Here, the query data 51 may be generated on the basis of a specific image 50. In addition, the system 100 for predicting a trajectory may use a pre-trained tokenizer to segment the query data 51 into a plurality of tokens according to predetermined criteria, and input the segmented plurality of tokens into the language model 121 that has undergone prompt engineering to predict the future trajectory 52 of the specific pedestrian.

With reference to FIGS. 13A to 13F, as another example, the system 100 for predicting a trajectory may input query data generated on the basis of a predetermined question-answer template into the language model that has undergone prompt engineering to predict the answer data generated on the basis of the question-answer template as the future trajectory of a specific pedestrian.

In this case, in the system 100 for predicting a trajectory, as answer data for the query data, the language model may output text in the form that includes the trajectory (or position coordinates, direction, similar walking pattern, group walking status, collision possibility, etc.) predicted based on the query data, in the text corresponding to the answer based on the question-answer template.

In addition, the system 100 for predicting a trajectory may generate a marker corresponding to the future trajectory of the pedestrian on the previously received image, on the basis of the trajectory output as the answer data from the language model.

Such markers may be generated in different forms depending on the form of the answer data according to the question-answer template. In an embodiment, (a) when the future position coordinates of a specific pedestrian are predicted on the basis of the question-answer template, the system 100 for predicting a trajectory may generate a marker (e.g., an “X” symbol) indicating the previously predicted position coordinates on the previously received image. In another embodiment, (b) when the future direction of movement for a specific pedestrian is predicted on the basis of the question-answer template, the system 100 for predicting a trajectory may generate a marker (e.g., an arrow symbol) on the previously received image to indicate the previously predicted direction of movement. In another embodiment, (c) when another pedestrian moving in a similar pattern to a specific pedestrian is predicted on the basis of the question-answer template, the system 100 for predicting a trajectory may generate a marker (e.g., a wavy line symbol) on the previously received image to indicate that the previously predicted pedestrian and other pedestrians are moving in a similar pattern.

In another embodiment, (d) when another pedestrian moving in the same group as a specific pedestrian is predicted on the basis of the question-answer template, the system 100 for predicting a trajectory may generate a marker (e.g., a grouping shape) on the previously received image to indicate that the previously predicted pedestrian and other pedestrians are included in the same group. In another embodiment, (e) when the possibility of a collision for a specific pedestrian is predicted on the basis of the question-answer template, the system 100 for predicting a trajectory may generate a marker (e.g., an exclamation mark symbol) on the previously received image to indicate the previously predicted collision possibility. In another embodiment, (f) when the future trajectory of a specific pedestrian is predicted on the basis of the question-answer template, the system 100 for predicting a trajectory may generate a marker (e.g., a line indicating the path) on the previously received image to represent the previously predicted future trajectory.

With the configurations as described above, the system 100 for predicting a trajectory according to the present invention may generate a prompt describing the past trajectory of a pedestrian from the image, and train the language model to be suitable for predicting the future trajectory of the pedestrian by performing prompt engineering on the language model using the generated prompt.

In addition, the system 100 for predicting a trajectory according to the present invention may input a question related to the future trajectory of a pedestrian into the language model that has undergone prompt engineering, thereby accurately predicting the trajectory that the corresponding pedestrian will proceed in the future.

Further, the present invention described above may be implemented as a program executed by one or more processes in an electronic device and stored on a computer-readable recording medium.

Therefore, the present invention may be implemented as computer-readable code or instructions on a medium in which the program is recorded. That is, the various control methods according to the present invention may be provided in the form of a program, either in an integrated or individual manner.

Meanwhile, the computer-readable medium includes all kinds of storage devices for storing data readable by a computer system. Examples of computer-readable media include hard disk drives (HDDs), solid state disks (SSDs), silicon disk drives (SDDs), ROMs, RAMS, CD-ROMs, magnetic tapes, floppy discs, and optical data storage devices.

Further, the computer-readable medium may be a server or cloud storage that includes storage and that the electronic device is accessible through communication. In this case, the computer may download the program according to the present invention from the server or cloud storage, through wired or wireless communication.

Further, in the present invention, the computer described above is an electronic device equipped with a processor, that is, a central processing unit (CPU), and is not particularly limited to any type.

Meanwhile, it should be appreciated that the detailed description is interpreted as being illustrative in every sense, not restrictive. The scope of the present invention should be determined on the basis of the reasonable interpretation of the appended claims, and all of the modifications within the equivalent scope of the present invention belong to the scope of the present invention.

What is claimed is:

1. A method of predicting a trajectory, comprising:
receiving an image capturing a pedestrian;
specifying position coordinates of the pedestrian on the basis of the image and generating a caption corresponding to the image using a pre-provided image captioning model;
generating a numerical coordinate prompt for a past trajectory of the pedestrian on the basis of the position coordinates, and generating a scene description prompt for surrounding situations of the pedestrian on the basis of the caption; and
predicting a trajectory of the pedestrian corresponding to the numerical coordinate prompt and the scene description prompt using a pre-trained language model.

2. The method of claim 1, wherein the predicting of the trajectory of the pedestrian includes inputting the numerical coordinate prompt and the scene description prompt into the pre-trained language model to perform prompt engineering on the language model.

3. The method of claim 2, wherein the performing of the prompt engineering includes:
segmenting each of the numerical coordinate prompt and the scene description prompt into a plurality of tokens using a pre-trained tokenizer according to predetermined criteria; and
performing prompt engineering on the language model using the segmented plurality of tokens.

4. The method of claim 1, wherein the predicting of the trajectory of the pedestrian includes generating query data related to a trajectory of a specific pedestrian appearing in the image, on the basis of at least one of the numerical coordinate prompt or the scene description prompt.

5. The method of claim 4, wherein the query data includes query data related to social relationship between the pedestrian and other pedestrians based on the trajectory of the specific pedestrian.

6. A system for predicting a trajectory, comprising:
an input unit configured to receive an image capturing a pedestrian; and
a control unit configured to predict a trajectory of the pedestrian based on the image using a pre-trained language model,
wherein the control unit is configured to:
specify position coordinates of the pedestrian on the basis of the image,
generate a caption corresponding to the image using a pre-provided image captioning model,
generate a numerical coordinate prompt for a past trajectory of the pedestrian on the basis of the position coordinates,
generate a scene description prompt for surrounding situations of the pedestrian on the basis of the caption, and
predict a trajectory of the pedestrian corresponding to the numerical coordinate prompt and the scene description prompt using the pre-trained language model.

7. A program stored on a computer-readable recording medium, and executed by one or more processes in an electronic device, the program comprising instructions to allow the program to perform:
receiving an image capturing a pedestrian;
specifying position coordinates of the pedestrian on the basis of the image and generating a caption corresponding to the image using a pre-provided image captioning model;
generating a numerical coordinate prompt for a past trajectory of the pedestrian on the basis of the position coordinates, and generating a scene description prompt for surrounding situations of the pedestrian on the basis of the caption; and
predicting a trajectory of the pedestrian corresponding to the numerical coordinate prompt and the scene description prompt using a pre-trained language model.

8. A language model training method, comprising:
receiving an image capturing a pedestrian;
specifying position coordinates of the pedestrian on the basis of the image and generating a caption corresponding to the image using a pre-provided image captioning model;
generating a numerical coordinate prompt for a past trajectory of the pedestrian on the basis of the position coordinates, and generating a scene description prompt for surrounding situations of the pedestrian on the basis of the caption;
predicting a trajectory of the pedestrian corresponding to the numerical coordinate prompt and the scene description prompt using a pre-trained first language model; and
labeling the predicted trajectory as correct answer data for query data, which is based on the numerical coordinate prompt and the scene description prompt, and training a second language model in an end-to-end manner using the query data and the trajectory so that, when query data for an arbitrary pedestrian is input, the second language model outputs a trajectory corresponding to the input query data.

9. A language model training system, comprising:
an input unit configured to receive an image capturing a pedestrian; and
a control unit configured to predict a trajectory of the pedestrian based on the image using a pre-trained first language model, and to train a second language model on the basis of the predicted trajectory,
wherein the control unit is configured to:
specify position coordinates of the pedestrian on the basis of the image,
generate a caption corresponding to the image using a pre-provided image captioning model,
generate a numerical coordinate prompt for a past trajectory of the pedestrian on the basis of the position coordinates,
generate a scene description prompt for surrounding situations of the pedestrian on the basis of the caption,
predict a trajectory of the pedestrian corresponding to the numerical coordinate prompt and the scene description prompt using the first language model,
label the predicted trajectory as correct answer data for query data, which is based on the numerical coordinate prompt and the scene description prompt, and
train the second language model in an end-to-end manner using the query data and the trajectory so that, when query data for an arbitrary pedestrian is input, the second language model outputs a trajectory corresponding to the input query data.

10. A program stored on a computer-readable recording medium, and executed by one or more processes in an electronic device, the program comprising instructions to allow the program to perform:
receiving an image capturing a pedestrian;
specifying position coordinates of the pedestrian on the basis of the image and generating a caption corresponding to the image using a pre-provided image captioning model;
generating a numerical coordinate prompt for a past trajectory of the pedestrian on the basis of the position coordinates, and generating a scene description prompt for surrounding situations of the pedestrian on the basis of the caption;
predicting a trajectory of the pedestrian corresponding to the numerical coordinate prompt and the scene description prompt using a pre-trained first language model; and
labeling the predicted trajectory as correct answer data for query data, which is based on the numerical coordinate prompt and the scene description prompt, and training a second language model in an end-to-end manner using the query data and the trajectory so that, when query data for an arbitrary pedestrian is input, the second language model outputs a trajectory corresponding to the input query data.
